(19) United States
(12) Patent Application Publication
(10) Pub. No.: US 2012/0016890 A1
(43) Pub. Date: Jan. 19, 2012

(54) ASSIGNING VISUAL CHARACTERISTICS TO RECORDS

(75) Inventors: Sukadev Bhattiprolu, Beaverton, OR (US); Venkateswararao Jujjuri, Beaverton, OR (US); Haren Myneni, Tigard, OR (US); Malahal R. Naineni, Tigard, OR (US); Badari Pulavarty, Beaverton, OR (US); Chandra Seetharaman, Portland, OR (US); Narasimha N. Sharoff, Beaverton, OR (US)

(73) Assignee: INTERNATIONAL BUSINESS MACHINES CORPORATION, Armonk, NY (US)

(21) Appl. No.: 12/837,328

(22) Filed: Jul. 15, 2010

(51) Int. Cl. G06F 17/30

(52) U.S. Cl. 707/752; 707/E17.104

(57) ABSTRACT

Systems, methods and computer program products are disclosed herein for assigning visual characteristics to records of a data structure and displaying those records. In response to an attribute being selected, records of the data structure may be sorted by values of the selected attribute of the records. A first set of records having values of the selected attribute that correspond to a first value may be identified. A second set of records having values of the selected attribute that correspond to a second value also may be identified. A first visual characteristic may automatically be assigned to each record of the first set of records and a second visual characteristic, that is different from the first visual characteristic, may be automatically assigned to each record of the second set of records.

### BACKGROUND

The present invention relates to systems, methods and computer program products containing instructions for assigning visual characteristics to records of data structures such as databases and emails. Records of data structures may have attributes with values. For example, emails may have values associated with various attributes, such as “Date,” “Sender” and “Subject.” It may be desirable to treat records having attribute values that correspond to each other (e.g. all emails sent from “richard@xyz.com”) similarly. In such a scenario, the records may be sorted by values of a selected attribute so that records having corresponding attribute values are grouped together visually. Once sorted, records having corresponding attribute values may be acted upon (e.g., deleted or moved to a particular logical location) together.

A user may wish to isolate records having a particular attribute value, which may require the user to sort the records and then visually scan the records closely to determine where records having one attribute value stop and records having a different attribute value start. However, when a data structure has hundreds or even thousands of records, the user may be more likely to make mistakes in identifying corresponding records, and identifying groups of like records may become cumbersome where all the records look similar and there is little to no visual indication separating groups of like records.

### BRIEF SUMMARY

Systems, methods and computer program products containing instructions for assigning visual characteristics to records are disclosed herein. Records of a data structure may be sorted by values of a selected attribute of the records. A first set of records having values of the selected attribute that correspond to a first value may be identified. A second set of records having values of the selected attribute that correspond to a second value may also be identified. A first visual characteristic may be automatically assigned to each record of the first set of records, and a second visual characteristic, that is different from the first visual characteristic, may be automatically assigned to each record of the second set of records.

### BRIEF DESCRIPTION OF THE SEVERAL VIEWS OF THE DRAWINGS

FIG. 1 depicts an exemplary data processing apparatus upon which disclosed methods and computer program products may be implemented.

FIG. 2 depicts an exemplary method of assigning visual characteristics to records of a data structure.

FIG. 3 depicts exemplary email data sorted by a selected attribute (date), each record having been assigned a visual characteristic.

FIG. 4 depicts the exemplary email data of FIG. 3, sorted by a different selected attribute (sender), each record having been assigned a visual characteristic.

FIG. 5 depicts the exemplary email data of FIGS. 3 and 4, sorted by another selected attribute (subject), where each record is assigned a visual characteristic based upon whether it has an attribute value that corresponds to a particular value.

FIG. 6 depicts the exemplary email data of FIGS. 3-5 sorted in a similar manner as shown in FIG. 5, where each record is assigned a visual characteristic based upon whether it is equal to a particular attribute value.

FIG. 7 depicts an exemplary method of displaying records with visual characteristics.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc) or an embodiment combining software and hardware aspects that may all generally be referred to herein as a “circuit.” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or cluster diagrams of methods, apparatus (systems) and computer program products according to embodiments of the invention. It will be understood that each cluster of the flowchart illustrations and/or cluster diagrams, and combinations of clusters in the flowchart illustrations and/or cluster-diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or cluster diagram cluster or clusters.

These computer program instructions may also be stored in a computer readable medium that can direct computer, other programmable data processing apparatus, or other devices to function in a particular manner, such that the instructions stored in the computer readable medium produce an article of manufacture including instructions which implement the function/act specified in the flowchart and/or cluster diagram cluster or clusters.

The computer program instructions may also be loaded onto a computer; other programmable data processing apparatus, or other devices to cause a series of operational steps to be performed on the computer, other programmable apparatus or ether devices to produce a computer implemented process such that the instructions which execute on the computer or other programmable apparatus provide processes for implementing the functions/acts specified in the flowchart and/or cluster diagram cluster or clusters.

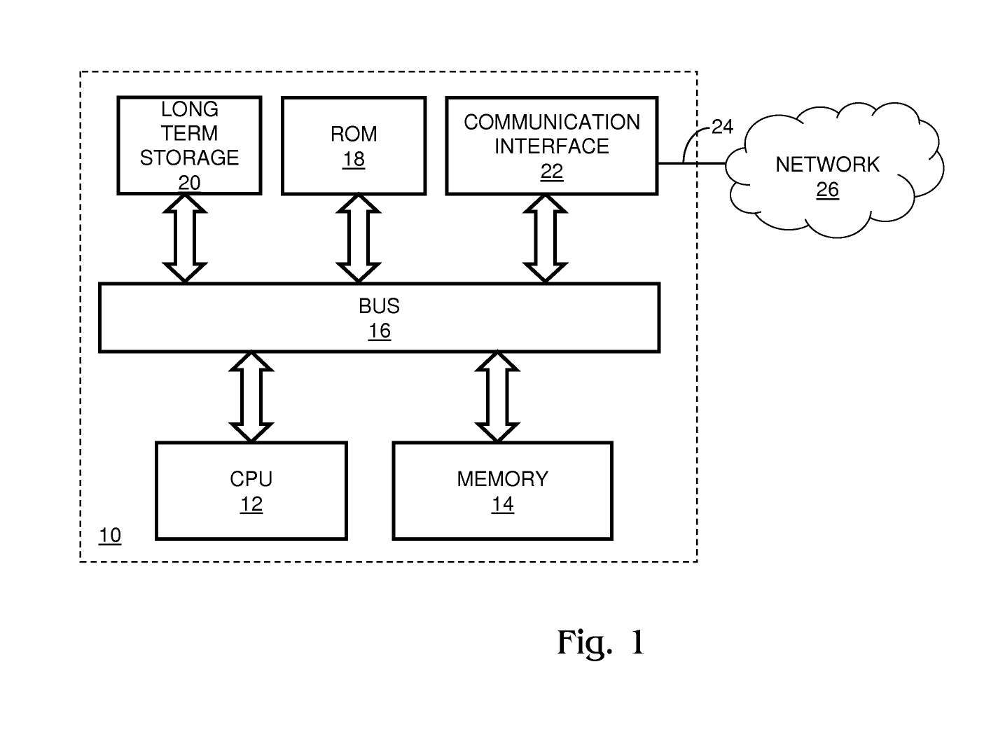

Referring to FIG. 1, an exemplary data processing apparatus 10 upon which disclosed methods and computer program products may be implemented is depicted. Data processing apparatus 10 may be a general or special purpose computer such as a personal computer, a laptop computer, a computer cluster (e.g., a blade system), a web server, a database server, a smart phone, a wireless email device; a tablet computer, a personal digital assistant, a network component (e.g., firewall, router, switch) and so forth. Data processing apparatus 10 may include a central processing unit 12 (“CPU”) and memory 14 (e.g., RAM) operably coupled by a bus 16. Data processing apparatus 10 may include additional components, such as ROM 18, long term storage 20 (e.g., hard disk), and one or more communication interfaces 22 through which a connection 24 may be established to communicate with other data processing apparatus on a network 26. Communication interface 22 may take various forms, such as an Ethernet card, a wireless adapter, a cellular interface, and so forth.

As noted above, systems, methods and computer program products are disclosed herein for assigning visual characteristics to records of a data structure. A data structure may be any series of data records, including a database, emails, text messages, employee records and so forth.

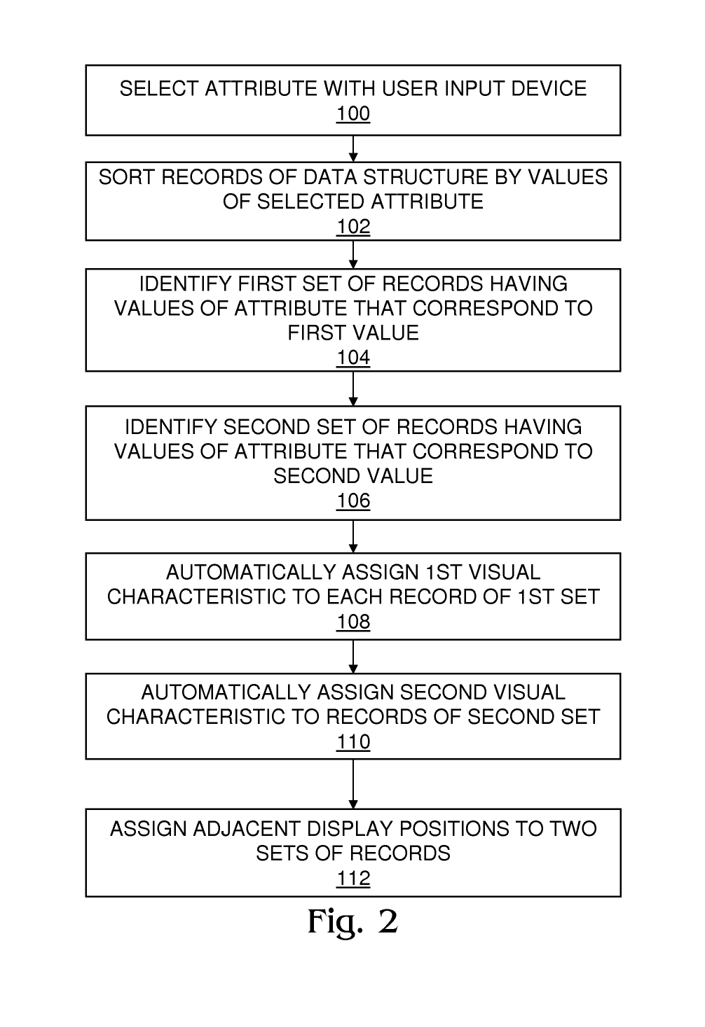

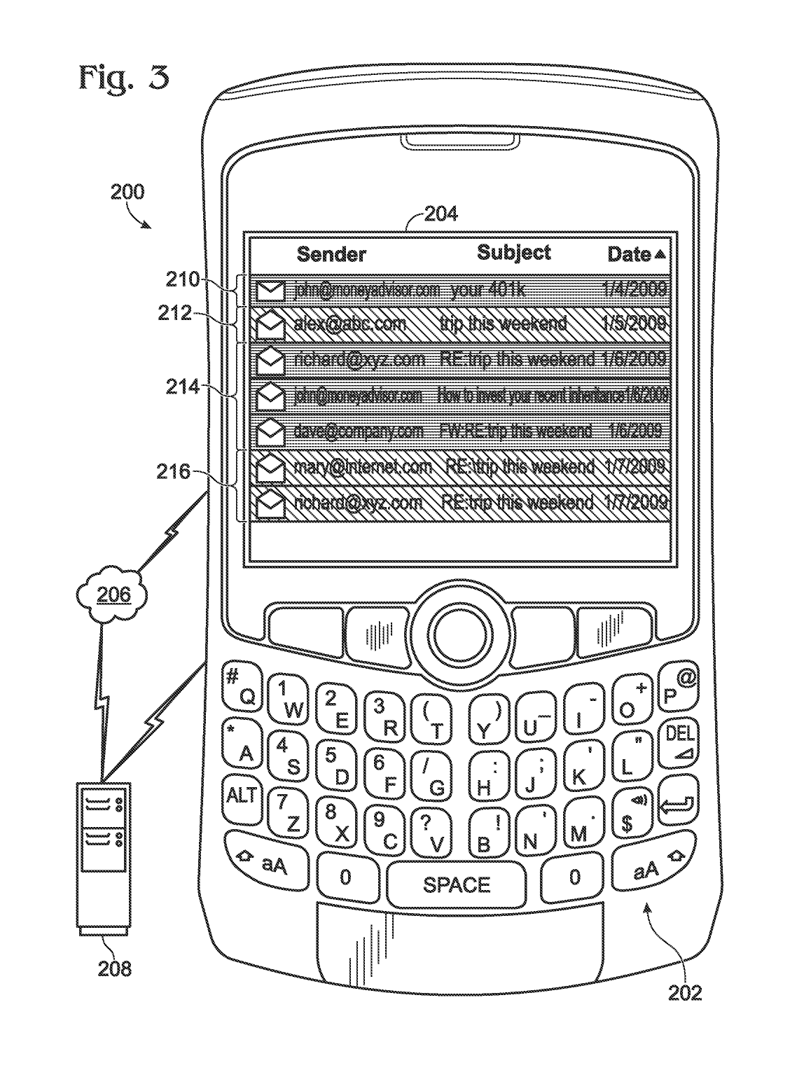

Referring now to FIG. 2, an exemplary method of assigning visual characteristics to records of a data structure is shown. In step 100, an attribute is selected using a user input device such as a mouse or a keyboard. Selecting the attribute may be accomplished in a number of ways. For example, a user may manipulate a user input device to select a heading (e.g., a column heading of a table) that corresponds to a particular attribute. Examples of this are seen in FIGS. 3-6, where in each figure, a column that has been selected includes a sort symbol ▴ that indicates which attribute is currently selected.

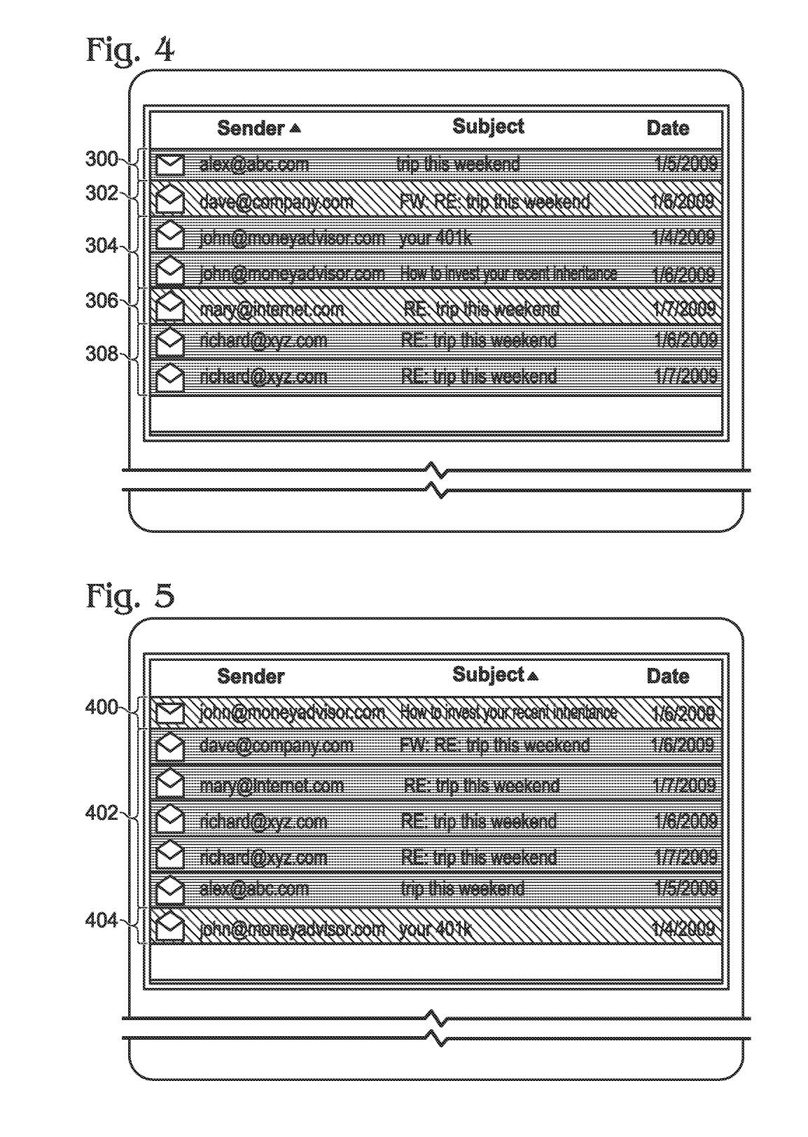

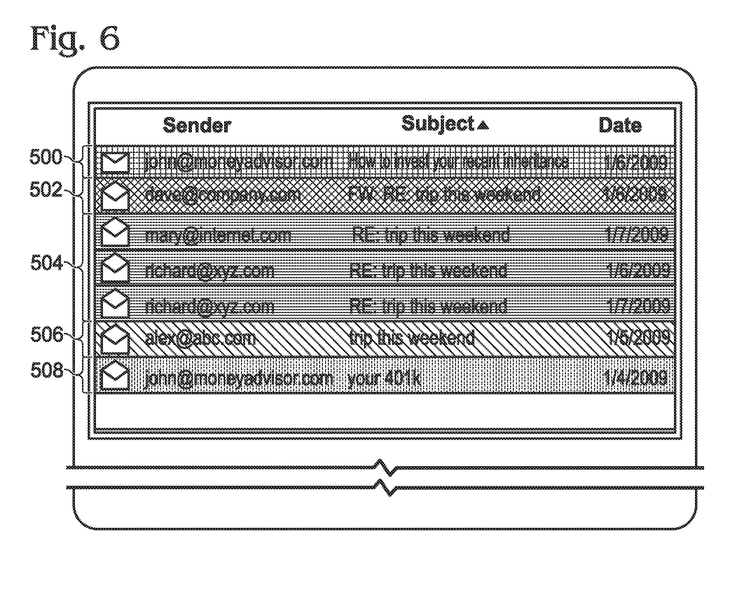

Referring back to the exemplary method of FIG. 2, in step 102, records of the data structure are sorted by values of the attribute that was selected in step 100. This can be seen in FIGS. 3-6, where the sort symbol ▴ indicates how the records are sorted by values of that attribute (e.g., ascending, descending). In FIG. 3, the records are sorted by date. In FIG. 4, the records are sorted by sender. In FIGS. 5 and 6, the records are sorted by subject.

In step 104, a first set of records having values of the selected attribute that correspond to a first value are identified. The first value may be the value of the selected attribute for the first record (after sorting). As used herein, a record has an attribute with a value that “corresponds to” another value where the values meet some relationship criteria. Exemplary relationship criteria may include equality (i.e., two records having identical attribute values), but also may be more flexible. For example, if a first value is a subset of a second value (e.g., “trip this weekend” is a subset of “RE: trip this weekend”), then the first value may be considered to “correspond to” the second value. The level of similarity required for values to match may be configured by the user.

In step 106, similar to step 104, a second set of records having values of the selected attribute that correspond to a second value are identified. The second value typically will be different than the first value, and in any event, values that correspond to the first value do not correspond to the second value.

In step 108, a first visual characteristic is automatically assigned to each record of the first set of records. “Visual characteristics” that may be assigned to records may include color (e.g., the text of the record or the record's background may be assigned a color), font (e.g., text of each record in a particular set may rendered in a particular font), outline of the records, and so forth.

In step 110, a second visual characteristic is automatically assigned to each record of the second set of records. The visual characteristic assigned to each record of the second set of records is different than the first visual characteristic assigned to each record of the first set of records. As a result, the first and second sets of records are visually distinguishable from each other when displayed and are identifiable as separate groups of related records.

Steps 106-110 may be repeated as many times as necessary in order to visually distinguish groups of records that are displayed. In some embodiments, such as those shown in FIGS. 3-5, sets of records are assigned the first visual characteristic or the second characteristic in an alternating manner, so that each set of records is visually distinguishable from adjacent sets of records. In other embodiments, such as that seen in FIG. 6, sets of records are assigned additional visual characteristics beyond the first and second visual characteristics.

As used herein, the term “automatically” means that the step that is modified by the term is performed without additional user input or action. In particular, one or more of steps 102-112 may be performed automatically after a user selects an attribute in step 100, without the user taking additional steps such as manually assigning visual characteristics to records of particular sets of records. For example, and as seen in FIGS. 3-6, sets of emails may be displayed in various colors without a user assigning a particular color to emails with a particular attribute value (e.g., all emails from “richard@xyz.com” should be yellow). Put another way, if a user selects a new attribute, records may be resorted and reassigned visual characteristics based solely on the records having attribute values that are different from adjacent groups of records, rather than particular records having predefined visual characteristics assigned.

In step 112, adjacent display positions are assigned to the first and second sets of records. For example, a web server implementing disclosed methods may, generate an HTML page to be delivered to a client web browser. In the HTML page, the first and second sets of records may be assigned positions adjacent each other, in a table for instance. In this manner, the web browser may display groups of records having different visual characteristics adjacent each other. In examples where disclosed methods are implemented on the same system (e.g., desktop computer, laptop computer, smart phone) at which the records are to be displayed, the first and second sets of records may be rendered adjacent to each other by the system's graphics hardware and/or software.

Examples where the visual characteristics assigned to records are colors are seen in FIGS. 3-6, where the depicted records are emails. FIG. 3 depicts a data processing apparatus 200 in the form of a smart phone configured to display emails. However, this is not meant to be limiting, and other types of data processing apparatus may be used to display records such as emails. Data processing apparatus 200 includes input controls 202, a display 204, and is connected through a network 206 (e.g., network 26 in FIG. 1) to one or more other data processing apparatus, such as second data processing apparatus 208.

As noted above, in some instances, methods and computer program products described herein for assigning visual characteristics to records may be implemented on separate data processing apparatus such as data processing apparatus 208, which in turn may communicate resulting information to data processing apparatus 200 for display. For example, data processing apparatus 208 may be a web server configured to generate HTML code dynamically and transmit it to data processing apparatus 200. The generated HTML code may include tables or other similar structures that are configured to cause a web browser computer program executing on data processing apparatus 200 to display the records with their assigned visual characteristics.

A first set of records 210 having values of the attribute “Date” that correspond to “Jan. 4, 2009” are identified (step 104) and assigned the color yellow (step 108). A second set of records 212 having values of the attribute “Date” that correspond to “Jan. 5, 2009” are identified (step 106) and assigned a first color (step 110). A third set of records 214 having values of the attribute “Date” that correspond to “Jan. 6, 2009” are identified (step 104) and assigned a second color that is different than the first color (step 108). A fourth set of records 216 having values of the attribute “Date” that correspond to “Jan. 7, 2009” are identified (step 106) and assigned the first color (step 110). In this manner, sets of records are visually distinguishable from one another, and particularly from adjacent sets of records.

In FIG. 4, the records of FIG. 3 are sorted by values of the attribute “Sender.” A first set of records 300 having values of the attribute “Sender” that correspond to “alex@abc.com” are identified (step 104) and assigned the first color (step 108). A second set of records 302 having values of the attribute “Sender” that correspond to “dave@company.com” are identified (step 106) and assigned the second color (step 110). A third set of records 304 having values of the attribute “Sender” that correspond to “john@moneyadvisor.com” are identified (step 104) and assigned the first color (step 108). A fourth set of records 306 having values of the attribute “Sender” that correspond to “mary@internet.com” are identified (step 106) and assigned the second color (step 110). A fifth set of records 308 having values of the attribute “Sender” that correspond to “richard@xyz.com” are identified (step 106) and assigned the first color (step 110).

In FIG. 5, the records of FIGS. 3 and 4 are sorted by values of the attribute “Subject.” A value of the Subject attribute for one record “corresponds to” a value of the Subject attribute for another record based on whether the two values share a particular degree of similarity (which may be configured by a user), rather than the values being identical. This correspondence may be based on each of the records having a value that is a subset of the longest value of the set, or in other manners, such as using regular expressions.

A first set of records 400 having values of the attribute “Subject” that correspond to “How to invest your recent inheritance” are identified (step 104) and assigned the first color (step 108). A second set of records 402 having values of the attribute “Subject” that correspond to “trip this weekend” are identified (step 106) and assigned the second color (step 110). It can be seen here that each of the records in the second set of records 402 has a value of the attribute “Subject” that is a subset of the value (“FW: RE: trip this weekend”). A third set of records 404 having values of the attribute “Subject” that correspond to “your 401k” are identified (step 104) and assigned the first color (step 108).

As noted above, the records in FIG. 6 are assigned additional visual characteristics beyond the first and second visual characteristics seen in FIGS. 3-5. In FIG. 6, records are once again sorted by values of the attribute “Subject.” Unlike FIG. 5, however, correspondence of attribute values in FIG. 6 based on equality, rather than a degree of similarity. A first set of records 500 having values of the attribute “Subject” that correspond to “How to invest your recent inheritance” are identified (step 104) and assigned a first color. A second set of records 502 having values of the attribute “Subject” that correspond to “FW: RE: trip this weekend” are identified (step 106) and assigned a second color. A third set of records 504 having values of the attribute “Subject” that equal “RE: trip this weekend” are identified (step 104) and assigned a third color. A fourth set of records 506 having values of the attribute. “Subject” that equal “trip this weekend” are identified (step 106) and assigned a fourth color. A fifth set of records 508 having values Of the attribute “Subject” that equal “your 401k” are identified (step 104) and assigned a fifth color.

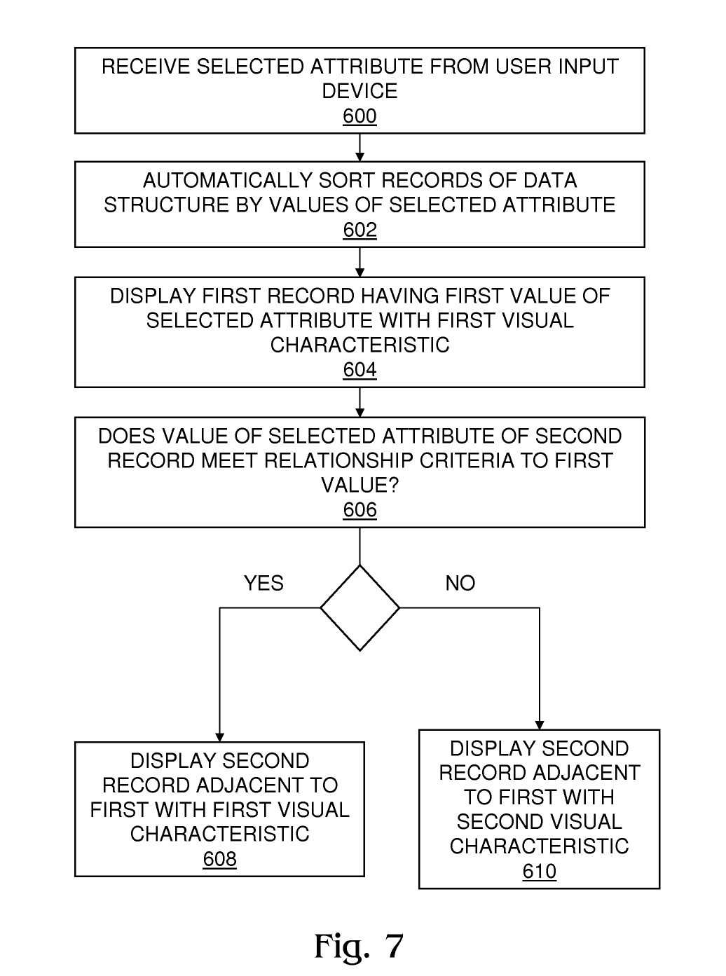

FIG. 7 depicts one example of how the method shown in FIG. 2 may be implemented on a system having a processor and memory connected by a bus such as data processing apparatus 10 in FIG. 1. Although the steps are shown in a particular order, it should be understood that this is not meant to be limiting, and the steps may be performed in other orders. In step 600, a selected attribute is received from a user input device such as a mouse or keyboard. For example, a user may manipulate the user input device to select a heading (e.g., column heading, row heading) corresponding to the selected attribute by which the users wishes to organize the records. Examples of this are seen in FIGS. 3-6, where the user selected the attributes “Date,” “Sender” and “Subject.” respectively.

In step 602, records of a data structure are automatically sorted by values of the attribute that was selected in step 600. Examples of this are seen in FIGS. 3-6, where the records 200 are sorted by the selected attributes “Date,” Sender” and “Subject.” respectively.

In step 604, a first record having a first value of the selected attribute is displayed with a first visual characteristic. In step 606, a value of the selected attribute of a second record is examined to determine whether meets a relationship criteria to the first value. If so, then in step 608, the second record is displayed adjacent the first record with the first visual characteristic. In this way, the second record is visually identifiable as being part of the same set as the first record.

If in step 606 it is determined that the value of the selected attribute of the second attribute does not meet a relationship criteria to the first value, then in step 610, the second record is displayed adjacent the first record with a second visual characteristic that is different from the first visual characteristic. In this manner, the second record is visually identifiable as being part of a different set than the first record. Steps 606-610 can be repeated for each record of a data set, in each case comparing a value of an attribute of a current record to a value of the same attribute of a previous (e.g., adjacent) record to determine whether the current record is part of the same set as the previous record, or if it is part of a new set.

The flowchart and cluster diagrams in the Figures illustrate the architecture, functionality, and operation of possible implementations of systems, methods and computer program products according to various embodiments of the present invention. In this regard, each cluster in the flowchart or cluster diagrams may represent a module, segment, or portion of code, which comprises one or more executable instructions for implementing the specified logical function(s). It should also be noted that, in some alternative implementations, the functions noted in the cluster may occur out of the order noted in the figures. For example, two clusters shown in succession may, in fact, be executed substantially concurrently, or the clusters may sometimes be executed in the reverse order, depending upon the functionality involved. It will also be noted that each cluster of the cluster diagrams and/or flowchart illustration, and combinations of clusters in the cluster diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “an” and “the” are intended to include the plural forms as well unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or clusters thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of assigning visual characteristics to records of a data structure, comprising:
sorting records of the data structure by values of a selected attribute of the records;
identifying a first set of records having values of the selected attribute that correspond to a first value;
identifying a second set of records having values of the selected attribute that correspond to a second value; and
automatically assigning a first visual characteristic to each record of the first set of records and a second visual characteristic, that is different from the first visual characteristic, to each record of the second set of records.

2. The method of claim 1, further comprising assigning the first set of records a first display position, and assigning the second set of records a second display position adjacent the first display position.

3. The method of claim 1, further comprising selecting the selected attribute via a user input device.

4. The method of claim 1, wherein the first visual characteristic is a first color and the second visual characteristic is a second color that is different from the first color.

5. The method of claim 1, wherein the data structure includes email records, and sorting records of the data structure by values of a selected attribute includes sorting the email records based on one of subject, sender and date attributes of the email records.

6. The method of claim 1, wherein the data structure includes employee records, and sorting records of the data structure by values of a selected attribute includes sorting the employee records based on one of name, employee number and social security number.

7. The method of claim 1, wherein identifying a first set of records having values of the selected attribute that correspond to a first value comprises identifying records having values of the selected attribute that are equal to the first value.

8. The method of claim 1, wherein identifying a first set of records having values of the selected attribute that correspond to a first value comprises identifying records having values of the selected attribute that are a subset of the first value.

9. The method of claim 2, further comprising:
identifying additional sets of records having values of the selected attribute that correspond to additional values; and
automatically assigning a visual characteristic to each record of each additional set of records, wherein a visual characteristic assigned to records of each additional set of records is different from a visual characteristic assigned to records of sets of records that are assigned to adjacent display positions.

10. A computer program product for displaying records, said computer program product including a plurality of computer executable instructions stored on a computer readable medium, wherein said instructions are executed by a computer to:
receive a selected attribute of the records from a user input device; and
in response to receiving the selected attribute from the user input device:
display a first record with a first visual characteristic, the first record having a selected attribute with a first value;
display a second record, adjacent to the first record, with the first visual characteristic where the selected attribute of the second record has a value that meets relationship criteria to the first value; and
display the second record, adjacent to the first record, with a second visual characteristic where the selected attribute of the second record has a value that does not meet relationship criteria to the first value.

11. The computer program product of claim 10, wherein the plurality of computer executable instructions further cause the computer to sort the records by values of the selected attribute.

12. The computer program product of claim 10, wherein the first visual characteristic is a first color and the second visual characteristic is a second color that is different from the first color.

13. A system for displaying records of a data structure, comprising:
a processor;
a memory; and
a records display program including a plurality of instructions stored in the memory that, in response to selection of an attribute, are executed by the processor to:
automatically sort records of the data structure by values of the selected attribute of the records;
automatically display, as a set presented in a first color, records having values associated with the selected attribute that correspond to a first value; and
automatically display, as a set presented in a second color that is different than the first color, adjacent records having values associated with the selected attribute that do not correspond to the first value.

14. The system of claim 13, wherein the records display program further includes instructions that are executed by the processor to obtain the selected attribute from a user input device in response to a user manipulating the user input device to select a heading corresponding to the selected attribute.

15. The system of claim 13, wherein values associated with the selected attribute that correspond to the first value are equal to the first value.

16. The system of claim 13, wherein the records are emails.

17. The system of claim 16, wherein the selected attribute is one of subject, sender and date.

18. The system of claim 13, wherein the records are employee records.

19. The system of claim 17, wherein the selected attribute is one of employee name, employee number and employee address.

20. The system of claim 13, wherein the records are text messages.
